(19) United States
(12) Patent Application Publication
(10) Pub. No.: US 2019/0029779 A1
(43) Pub. Date: Jan. 31, 2019

(54) DENTAL FITTING ATTACHABLE TO A DENTAL COMPONENT AND DENTAL ASSEMBLY COMPRISING THE DENTAL FITTING

(71) Applicant: NOBEL BIOCARE SERVICES AG, Kloten (CH)

(72) Inventors: Stephan Vonwiller, Winterthur (CH); Jorg Weitzel, Rielasingen-Worblingen (DE); Piers Christiansen, Zurich (CH); Andrew Corbin, Zurich (CH)

(21) Appl. No.: 16/069,480

(22) PCT Filed: Jan. 16, 2017
(86) PCT No.: PCT/EP2017/050800

§ 371 Date: Jul. 11, 2018

(30) Foreign Application Priority Data
Jan. 14, 2016 (EP) EP16151231.4

(51) Int. Cl. A61C 8/00; A61C 13/265

(52) U.S. Cl. CPC A61C 8/0062; A61C 13/2656; A61C 8/0054

(57) ABSTRACT

The invention relates to a dental fitting (1, 1′, 101, 101′, 101″) attachable to a dental component (30), such as a dental implant. The dental fitting (1, 1′, 101, 101′, 101″) comprises a main body (2, 2′) and a retention element (4, 104, 104′, 104″) provided apically to the main body (2, 2′). The retention element (4, 104, 104′, 104″) comprises an attachment portion (6, 106, 106′, 106″) for attaching the dental fitting (1, 1′, 101, 101′, 101″) to the dental component (30). The retention element (4, 104, 104′, 104″) has a closed ring shape or an open ring shape in a cross-section perpendicular to the direction from the attachment portion (6, 106, 106′, 106″) towards a coronal end (8) of the main body (2, 2′). The attachment portion (6, 106, 106′, 106″) comprises at least one projection (10, 110, 110′, 110″) extending in one or more directions substantially perpendicular to the direction from the attachment portion (6, 106, 106′, 106″) towards the coronal end (8) of the main body (2, 2′). The retention element (4, 104, 104′, 104″) is integrally formed with or integrally attached to the main body (2, 2′).

### FIELD OF THE INVENTION

The present invention relates to a dental fitting, such as an abutment, attachable to a dental component, such as a dental implant. Further, the invention relates to a dental assembly comprising such a dental fitting and the dental component and to a method of attaching such a dental fitting to the dental component.

### BACKGROUND ART

Dental prostheses, such as dental crowns or dental bridges, are widely used for the treatment of partly or fully edentulous patients. These prostheses are commonly attached to dental implants placed in a patient's jaw bone with the use of an abutment arranged between implant and prosthesis. For this purpose, single-piece abutments, consisting of a single piece, or multi-piece abutments, comprising two or more separate pieces, may be employed.

When providing a patient with a dental prosthesis, the abutment has to be attached to the implant placed in the patient's jaw bone. Further, for the case of a multi-piece abutment, the different pieces of the abutment have to be attached to each other. Moreover, other dental fittings, such as impression taking components, e.g., open or closed tray impression posts, intra-oral scanning or desk top scanning locators, healing caps, temporary restorations etc., may have to be attached to the implant in the treatment process.

In these attachment processes, misfits or misalignments between the dental fitting and the dental component may occur, rendering the attachment complicated and causing the risk of improper placement of the dental fitting.

In particular, when mounting an abutment to a dental implant, it is difficult for a clinician to assess whether the abutment is properly seated, i.e., fully engaged with the implant. If the abutment is fixed to the implant in an incorrect position, e.g., by engaging and tightening a clinical screw, problems, such as an improper placement of the dental prosthesis, the formation of undesired gaps between different components etc., can arise. These difficulties in attaching the abutment to the implant are further aggravated if the implant is placed in the patient's upper jaw bone, due to gravity.

One possible way of verifying whether the abutment is correctly seated in the implant is to take an X-ray image of the patient's jaw bone with the abutment in place. However, this approach renders the attachment process inefficient and expensive.

In order to prevent fixation of the abutment to the implant in an incorrect position, it is known to provide a height lift that prevents a clinical screw from engaging with the implant if the abutment is not fully seated. In this case, the abutment cannot be secured to the implant in an improper position by the clinician. However, this means that the clinician has to repeat the steps of removing the screw, checking the position of the abutment and reinserting the screw until the screw can be engaged, thus rendering the attachment process inefficient and cumbersome. Further, there are several possible reasons why the screw may not properly engage with the implant, such as an incorrect insertion of the screw or damaged threads on the screw and/or the implant. Hence, the fact that the screw cannot be engaged is not an unambiguous indication of an incorrect placement of the abutment.

U.S. Pat. No. 8,033,826 B2 discloses an abutment for use with a dental implant. The abutment comprises a prosthetic portion adapted to support a prosthesis thereon and an insert. The insert extends into a passageway of the prosthetic portion and engages the subgingival end of the prosthetic portion. The insert includes flexible retention fingers that, upon insertion into the passageway, initially contract before reaching an enlarged retention groove and then expand outwardly into the enlarged retention groove to hold the insert onto the prosthetic portion.

A similar abutment is disclosed in U.S. Pat. No. 7,484,959 B2. In particular, U.S. Pat. No. 7,484,959 B2 teaches an abutment which is provided with resilient fingers to interface with an implant.

However, in the case of the abutments disclosed in U.S. Pat. No. 8,033,826 B2 and U.S. Pat. No. 7,484,959 B2, only the fingers, which form a small part of the entire abutment, are flexible. Hence, these fingers are prone to wear and breakage, in particular, if the abutment is repeatedly engaged with and removed from the prosthetic portion. For example, in a dental laboratory, a technician will have to engage and remove a prosthetic portion or other dental components repeatedly. Moreover, for example, also in the case that a patient is provided with a temporary restoration, the insert will have to be engaged and removed a number of times.

Hence, there remains a need for a reliable and efficient approach for attaching a dental fitting, such as an abutment, to a dental component, such as a dental implant, in particular, an approach which may provide a clear indication of whether the dental fitting and the dental component are properly attached to each other.

### SUMMARY OF THE INVENTION

Accordingly, it is an object of the present invention to provide a dental fitting, such as an abutment, which is attachable to a dental component, such as a dental implant, in a reliable and efficient manner, in particular, which may efficiently provide reliable, indication of whether the dental fitting and the dental component are properly attached to each other. Further, the invention aims to provide a dental assembly comprising such a dental fitting and a method of attaching such a dental fitting to the dental component.

These goals are achieved by a dental fitting with the technical features of claim 1, by a dental fitting with the technical features of claim 2, by a dental assembly with the technical features of claim 21 and by a method with the technical features of claim 22.

The invention provides a dental fitting, such as an abutment, attachable to a dental component, such as a dental implant. The dental fitting comprises a main body and a retention element provided apically to the main body. The retention element comprises an attachment portion for attaching the dental fitting to the dental component. The retention element has a closed ring shape or an open ring shape in a cross-section perpendicular to the direction from the attachment portion towards a coronal end of the main body. The attachment portion comprises at least one projection extending in one or more directions substantially perpendicular to the direction from the attachment portion towards the coronal end of the main body. The retention element is integrally formed with or integrally attached to the main body.

The at least one projection may have a coronal surface which is inclined relative to the direction from the coronal end of the main body towards the attachment portion at an angle of less than 90°. The coronal surface of the at least one projection is thus arranged such that the radially outward extension of the coronal surface, i.e., the outward extension of the coronal surface in one or more radial directions of the retention element, increases along the direction from the coronal end of the main body towards the attachment portion. Hence, the radially outward extension of the coronal surface is smaller at positions closer to the coronal end of the main body than at positions further away from the coronal end of the main body in the direction from the coronal end of the main body towards the attachment portion.

The at least one projection may have a coronal surface which is inclined relative to an outer wall surface of the portion of the remainder of the retention element from which the at least one projection projects at an angle of less than 90°.

The retention element may have an open ring shape or open annular shape, i.e., the shape of a ring with a single opening in the circumference thereof, or substantially a C-shape, in a cross-section perpendicular to the longitudinal direction of the retention element. The single opening extends from an apical end of the retention element to a coronal end of the retention element.

The retention element may have a closed ring shape or closed annular shape, i.e., the shape of a ring without an opening in the circumference thereof.

The retention element is integrally formed with or integrally attached to the main body. The retention element thus forms an integral part of the dental fitting, such as an abutment for attaching a dental prosthesis, e.g., a dental crown or a dental bridge, to a dental implant.

The attachment portion of the retention element comprises at least one projection or protrusion extending from an outer surface of the remainder of the retention element in one or more directions substantially perpendicular to the direction from the attachment portion towards the coronal end of the main body.

The at least one projection or protrusion of the attachment portion is configured to be received in a corresponding cavity formed in a coronal portion of the dental component, such as a dental implant.

The dental fitting, such as an abutment, is attached to the dental component, such as a dental implant, by attaching the attachment portion of the retention element to the dental component.

In particular, when attaching the attachment portion of the retention element to the dental component, the retention element can be initially elastically deformed, i.e., elastically compressed, along one, some or all transverse directions, i.e., radial directions, of the retention element and subsequently restored to its initial shape when the at least one projection or protrusion has been received in the corresponding cavity of the dental component, due to the restoring force of the retention element. Hence, the attachment portion can be attached to the dental component by snap fit in a reliable and efficient manner. The engagement of the at least one projection or protrusion of the attachment portion with the corresponding cavity of the dental component provides an audible and/or tactile feedback to a user, such as a clinician or a technician, e.g., in a dental laboratory, providing a clear and unambiguous indication that the retention element, and thus also the dental fitting, is properly attached to the dental component.

The open or closed ring shape of the retention element provides a particularly robust configuration, enabling attachment of the dental fitting to the dental component in a reliable manner. In particular, this open or closed ring shape allows for the forces acting on the retention element during the attachment process to be distributed in a substantially uniform manner.

Hence, the risk of wear or breakage of the retention element can be considerably reduced, even if the retention element is repeatedly engaged with and removed from the dental component.

The inclination of the at least one projection relative to the direction from the coronal end of the main body towards the attachment portion at an angle of less than 90° provides improved guidance of the dental fitting when attaching the fitting to the dental component. In particular, this inclination facilitates the process of receiving the at least one projection in the corresponding cavity of the dental component and can act so as to pull the dental fitting into the attachment position.

Therefore, the invention provides a dental fitting which is attachable to a dental component, such as a dental implant, in a reliable and efficient manner.

The retention element may be integrally formed with the main body. Herein, the term “integrally formed” denotes that the retention element and the main body of the dental fitting are formed as a single piece, i.e., in a one-piece configuration. Forming the retention element and the main body of the dental fitting as a single piece allows for the dental fitting to be manufactured in a particularly simple and efficient manner, e.g., by injection moulding, milling, such as CNC milling, etc.

The retention element may be integrally attached to the main body. Herein, the term “integrally attached” denotes that the retention element is attached to the main body of the dental fitting in such a manner that the retention element cannot be detached or separated from the main body without damaging or destroying the retention element and/or the main body.

Since the retention element is integrally formed with or integrally attached to the main body, a particularly robust and stable configuration of the dental fitting is achieved.

The retention element may be provided at an apical end of the main body. Alternatively, the retention element may be provided at an intermediate portion of the main body located between the apical end and the coronal end of the main body.

The attachment portion of the retention element may be an apical attachment portion.

The retention element may have a substantially cylindrical shape, e.g., with a substantially circular cross-section perpendicular to the direction from the attachment portion towards the coronal end of the main body, i.e., the longitudinal direction of the retention element, that is, the axial direction thereof.

The at least one projection or protrusion of the attachment portion of the retention element extends in one or more directions substantially perpendicular to the longitudinal direction of the retention element, i.e., in one or more transverse directions thereof. In particular, the attachment portion may comprise at least one projection or protrusion which extends in plural transverse directions of the retention element, i.e., extends along a portion of the outer surface of the remainder of the retention element in the circumferential direction of the retention element. The at least one projection or protrusion may extend along 5% or more, 10% or more, 20% or more or 30% or more of the outer circumference of the remainder of the retention element. As a non-limiting example, the at least one projection may extend along 7% of the outer circumference of the remainder of the retention element. In other words, the at least one projection may extend on 25° in a radial direction ((25°/360°=) 7%).

The dental fitting may be, for example, an abutment, e.g., a single-piece or a multi-piece abutment, a scan abutment, a temporary abutment, an abutment position locator, an impression taking component, such as an open or closed tray impression post or an impression coping, e.g., a screw-less impression coping, an intra-oral scanning or desk top scanning locator, a healing cap, a temporary restoration or a final restoration.

The dental component may be, for example, a dental implant or an implant analogue, e.g., for use in a dental laboratory.

For the case of a multi-piece abutment, e.g., a two-piece abutment, the dental fitting may be one piece of the abutment and the dental component may be another piece of the abutment. In this case, the one piece of the abutment comprises the retention element and can be attached to the other piece of the abutment through the retention element. Alternatively or in addition thereto, a base piece or unit of the multi-piece abutment may comprise the retention element and be attached to a dental implant by the retention element.

For example, in case of a two-piece abutment comprising a base part intended to be attached to a dental implant and an upper part, for example intended support a dental prosthesis, one part or both parts of the two piece abutment may be a dental fitting according to the invention. In other words, the upper part of the two-piece abutment can comprise the retention element and can be attached to the base part of the two piece abutment through the retention element. Alternatively or in addition thereto the base part of the two-piece abutment may also be a dental fitting according to the invention and may be attached to a dental implant by the retention element.

The dental fitting and/or the dental component may be made of, for example, a metal, such as titanium, a titanium alloy or stainless steel, a ceramic, a polymer or a composite material.

In particular, the dental fitting may be an abutment made of a ceramic, a metal, such as titanium, a titanium alloy or stainless steel, a polymer or a composite material. The dental component may be a dental implant made of, for example, a metal, such as titanium, a titanium alloy or stainless steel.

The retention element and the main body of the dental fitting may be made from the same material or from different materials. If the retention element is made of a material which is different from that of the main body, the retention force provided by the retention element can be set in a particularly simple manner.

The invention further provides a dental fitting, such as an abutment, attachable to a dental component, such as a dental implant. The dental fitting comprises a main body and a retention element provided apically to the main body. The retention element comprises an attachment portion for attaching the dental fitting to the dental component. The retention element has a closed ring shape or an open ring shape in a cross-section perpendicular to the direction from the attachment portion towards a coronal end of the main body. The attachment portion comprises at least two projections, each extending in one or more directions substantially perpendicular to the direction from the attachment portion towards the coronal end of the main body. The at least two projections are spaced from each other in the circumferential direction of the retention element. The retention element is integrally formed with or integrally attached to the main body.

The provision of the ring shaped retention element with the at least two projections which are spaced from each other in the circumferential direction of the retention element offers improved guidance of the dental fitting when attaching the fitting to the dental component.

The dental fitting of the invention is thus attachable to a dental, component, such as a dental implant, in a reliable and efficient manner.

The retention element may be configured so that a lower force is required for radially displacing, in a radially inward direction, i.e., towards a centre of the retention element, one of the at least two projections than for radially displacing, in a radially inward direction, i.e., towards the centre of the retention element, the other of the at least two projections. The other of the at least two projections can thus particularly reliably act as a guide projection, guiding the dental fitting when attaching the fitting to the dental component. The other of the at least two projections may not be radially displaceable or be less radially displaceable than the one of the at least two projections.

A portion of the main body, in particular, an apical portion of the main body, may have a non-round cross-section perpendicular to the direction from the attachment portion towards the coronal end of the main body.

A portion of the main body, in particular, an apical portion of the main body, may have a cross-section perpendicular to the direction from the attachment portion towards the coronal end of the main body which has a number of main directions in which the radius measuring the distance between the centre of the cross-section and its outer contour takes a relative maximum value and thus a higher value than in neighbouring orientations.

A portion of the main body, in particular, an apical portion of the main body, may have a trioval cross-section perpendicular to the direction from the attachment portion towards the coronal end of the main body.

The other of the at least two projections may be arranged at a circumferential or angular position where the radius measuring the distance between the centre of the cross-section and its outer contour takes a relative maximum value, e.g., at a maximum of a trioval cross-section. The other of the at least two projections may have a radial extension which is smaller than the maximum radius between the centre of the cross-section and its outer contour, e.g., at a maximum of a trioval cross-section. In this case, the other of the at least two projections is arranged radially inward from the outer contour of the cross-section.

The one of the at least two projections may be arranged at a circumferential position where the radius measuring the distance between the centre of the cross-section and its outer contour takes a relative minimum value, e.g., at a minimum of a trioval cross-section. The one of the at least two projections may have a radial extension which is larger than the minimum radius between the centre of the cross-section and its outer contour, e.g., at a minimum of a trioval cross-section. In this case, the one of the at least two projections is arranged so as to radially extend beyond the outer contour of the cross-section.

In this case, the one of the at least two projections can come into contact with an inner wall of the dental component before the other of the at least two projections comes into contact with this inner wall, when attaching the dental fitting to the dental component, thus helping to guide and/or align the fitting in the attachment process.

The at least two projections may be equidistantly spaced from each other or spaced from each other at different intervals in the circumferential direction of the retention element.

The retention element may be elastically deformable at least in all directions perpendicular to the direction from the attachment portion towards the coronal end of the main body.

Thus, the entire retention element of the dental fitting may be elastically deformable. The retention element may be elastically deformable along its entire length. The length of the retention element extends along the longitudinal direction thereof, i.e., the axial direction thereof, that is, the direction from the attachment portion towards the coronal end of the main body, i.e., the direction from an apical end of the retention element towards a coronal end of the retention element.

The entire retention element can thus be elastically deformed at least in or along all directions perpendicular to the direction from the attachment portion towards the coronal end of the main body, i.e., in or along all the transverse directions of the retention element, that is, all the radial directions of the retention element.

An elastic deformability of the main body in the directions perpendicular to the direction from the attachment portion towards the coronal end of the main body may be lower than that of the retention element. The main body may not be elastically deformable in the directions perpendicular to the direction from the attachment portion towards the coronal end of the main body.

The whole retention element, rather than only a portion thereof, may be elastically deformable along its transverse directions. In this way, a particularly high degree of flexibility of the retention element can be achieved. Further, the entire retention element can be elastically deformed upon attachment of the dental fitting to the dental component, thus minimising the risk of wear or breakage of the retention element, even if the retention element is repeatedly engaged with and removed from the dental component.

Therefore, a clear, reliable and efficient indication of whether the dental fitting is properly attached to the dental component can be provided.

The retention element may have a wall thickness in the range of 0.02 mm to 0.50 mm, preferably in the range of 0.04 mm to 0.20 mm, more preferably in the range of 0.05 mm to 0.17 mm and even more preferably in the range of 0.10 mm to 0.16 mm. The retention element may be formed of a TiAlV alloy.

The retention element may be formed of a material having a Young's modulus in the range of 95 to 120 GPa and preferably in the range of 98-110 GPa. The retention element may be, for example, formed of a material having a Tensile yield strength (0.2% strain) in the range of 795-975 MPa. For example, the retention element may be formed of a TiAlV alloy.

The coronal surface of the at least one projection or the at least two projections may be inclined relative to the direction from the coronal end of the main body towards the attachment portion at an angle of 25° or more, preferably 30° or more. In this way, it can be particularly reliably ensured that the dental fitting is securely held in the attachment position.

The coronal surface of the at least one projection or the at least two projections may be inclined relative to the direction from the coronal end of the main body towards the attachment portion at an angle of less than 90°, preferably at an angle of not more than 80°.

The retention element may have at least one portion extending from an apical end of the retention element to a coronal end of the retention element, the at least one portion being more flexible than the remainder of the retention element. This flexible portion of the retention element contributes to or even provides the elastic deformability of the retention element. Hence, the retention element can be configured in an elastically deformable manner in a simple and efficient way.

The at least one portion extending from the apical end of the retention element to the coronal end of the retention element may be made or formed of a material which is more flexible than a material of the remainder of the retention element. Alternatively or additionally, the at least one portion may have a configuration or structure with a higher degree of flexibility than the configuration or structure of the remainder of the retention element. For example, the at least one portion may be made more flexible by providing, for example, perforations, recesses, openings or the like therein. Also, e.g., the at least one portion may have a smaller thickness, i.e., wall thickness, than the remainder of the retention element.

The retention element may have two or more, three or more or four or more portions extending from the apical end of the retention element to the coronal end of the retention element, these portions being more flexible than the remainder of the retention element.

The retention element may have at least one cut-out or recessed portion extending from the apical end of the retention element to the coronal end of the retention element. The at least one cut-out or recessed portion contributes to or even provides the elastic deformability of the retention element. Forming the retention element with such an at least one cut-out or recessed portion provides a particularly flexible configuration of the retention element. Further, the retention element has an especially simple structure.

The retention element may be a hollow and/or tubular body, wherein the at least one cut-out or recessed portion penetrates an outer wall of the retention element.

The retention element may be integrally formed with or integrally attached to the main body through one or more link portions arranged between the retention element and the main body. The one or more link portions may be arranged between the retention element and the main body in the longitudinal direction of the retention element. Each of the one or more link portions may extend along only a part of the retention element in a circumferential direction of the retention element.

In this way, the retention element can be integrated with the main body of the dental fitting in a particularly simple and
reliable manner.

At least one or some of the one or more link portions may extend along 5% or more, 10% or more, 20% or more, 30% or more, or 40% or more of the circumference of the retention element. Each of the one or more link portions may extend along 5% or more, 10% or more, 20% or more, 30% or more, or 40% or more of the circumference of the retention element. In particular embodiment, at least one of the one or more link portions extends along 7% of the circumference of the retention element.

At least one or some of the one or more link portions may extend along 10% or less, 20% or less, 30% or less, 40% or less, 50% or less, 60% or less, 70% or less, or 80% or less of the circumference of the retention element. Each of the one or more link portions may extend along 10% or less, 20% or less, 30% or less, 40% or less, 50% or less, 60% or less, 70% or less, or 80% or less of the circumference of the retention element.

The retention element may be integrally formed with or integrally attached to the main body through a plurality of link portions, e.g., two link portions, three link portions, four link portions or five link portions, the link portions being arranged between the retention element and the main body. The link portions may be separated from each other in the circumferential direction of the retention element, i.e., respectively arranged so that there is a gap between adjacent link portions in the circumferential direction of the retention element. The link portions may be equidistantly spaced from each other in the circumferential direction of the retention element or spaced from each other at different intervals in the circumferential direction of the retention element. The link portions may have the same or different extensions along the circumference of the retention element, i.e., in the circumferential direction of the retention element.

The retention element may be integrally formed with or integrally attached to the main body through a single link portion. The retention element may have a single portion extending from the apical end of the retention element to the coronal end of the retention element, the single portion being more flexible than the remainder of the retention element. The single link portion may be arranged opposite to the single portion in the radial direction of the retention element or adjacent to the single portion in the circumferential direction of the retention element.

The retention element may be integrally formed with or integrally attached to the main body through a single link portion. The retention element may have a single cut-out or recessed portion extending from the apical end of the retention element to the coronal end of the retention element. The single link portion may be arranged opposite to the cut-out or recessed portion in the radial direction of the retention element or adjacent to the cut-out or recessed portion in the circumferential direction of the retention element.

The retention element may be integrally formed with or integrally attached to the main body through a single link portion. The single link portion may be arranged opposite to the at least one projection or protrusion of the attachment portion in the radial direction of the retention element or adjacent to the at least one projection or protrusion of the attachment portion in the circumferential direction of the retention element.

The retention element may be integrally formed with or integrally attached to the main body through at least two link portions. The at least two link portions may be arranged opposite to each other in the radial direction of the retention element.

The attachment portion of the dental fitting may comprise a plurality of, e.g., two or more, three or more, four or more, or five or more, six or more, projections or protrusions, each extending in one or more directions substantially perpendicular to the direction from the attachment portion towards the coronal end of the main body.

One, some or all of the plurality of projections may have a coronal surface which is inclined relative to the direction from the coronal end of the main body towards the attachment portion at an angle of less than 90°. One, some or all of the plurality of projections may have a coronal surface which is inclined relative to an outer wall surface of the portion or portions of the remainder of the retention element from which the respective projection or projections projects or project, respectively, at an angle of less than 90°.

The plurality of projections or protrusions may have the same or different extensions in the circumferential direction of the retention element. The plurality of projections or protrusions may have the same or different protruding heights from an outer surface of the remainder of the retention element, i.e., heights from this outer surface in one or more directions substantially perpendicular to the direction from the attachment portion towards the coronal end of the main body.

The plural projections or protrusions of the attachment portion may be sequentially or consecutively arranged in the circumferential direction of the retention element, i.e., so that one is arranged after the other in this circumferential direction. The plural projections or protrusions may be equidistantly spaced from each other or spaced from each other at different intervals in the circumferential direction of the retention element.

The plural projections or protrusions of the attachment portion are configured to be received in a corresponding cavity or corresponding cavities formed in the coronal portion of the dental component, such as a dental implant.

As has been detailed above, the retention element may have at least one portion extending from the apical end of the retention element to the coronal end of the retention element, the at least one portion being more flexible than the remainder of the retention element. The retention element may have at least one cut-out or recessed portion extending from the apical end of the retention element to the coronal end of the retention element. At least one projection or protrusion of the attachment portion of the dental fitting may be arranged adjacent to the at least one more flexible portion or the at least one cut-out or recessed portion of the retention element. In this way, a particularly reliable and efficient snap fit connection between the retention element and the dental component can be ensured.

The dental fitting may further comprise a through hole extending through the dental fitting in the direction from a coronal end of the dental fitting to an apical end of the dental fitting. In this case, the dental fitting, such as an abutment, can be fixed to the dental component, such as a dental implant, via the retention element by means of a fixing element, such as a screw, that passes through the through hole formed in the dental fitting.

In particular, the dental fitting may be provided with a through hole having a screw seat for retaining a head of the screw. A threaded lower portion of the screw may be inserted into a threaded bore formed in the dental component, so that the dental fitting can be reliably fixed to the dental component via the retention element by means of the screw. By providing the dental fitting with such a through hole, a reversible fixed connection between the dental fitting and the dental component, i.e., a connection that can be easily released, can be obtained.

The dental fitting may have a marking, such as a colour code. Such a marking ensures that an incorrect use of the dental fitting is prevented. For example, the marking, such as the colour code, may indicate an outer diameter of the attachment portion. The marking, e.g., the colour code, may indicate a platform size of the dental component, e.g., a dental implant, which is to be used with the dental fitting. The marking may be provided on the retention element.

The dental fitting may comprise an indication and/or tracking device, such as an RFID tag. The indication and/or tracking device may provide information on the dental component to be used with the dental fitting, such as platform sizes, connection types, implant types, implant sizes and lengths, date of placement, primary stability etc. The indication and/or tracking device, such as an RFID tag, may be housed or received in the dental fitting. In particular, the indication and/or tracking device may be housed or received in the retention element, e.g., in a wall thereof or in a projection or protrusion of the attachment portion.

The retention element may be formed of a single material. The retention element may be made of, for example, a metal, such as titanium, a titanium alloy, e.g., a TiAlV alloy, or stainless steel, a polymer or a composite material. In this way, the retention element can be configured in an elastically deformable manner in a particularly simple and reliable way.

The material of the retention element may be metallic, superelastic, amorphous etc.

The retention element may be manufactured, for example, by injection moulding, milling, such as CNC milling, etc. For example, the retention element may be manufactured by injection moulding using coloured plastic, e.g., so as to provide a colour code as a marking. If the retention element is made of a metal, such as titanium, a titanium alloy or stainless steel, the retention element may be anodised.

The invention further provides a dental assembly comprising the dental fitting of the invention and a dental component, such as a dental implant. The explanations and definitions provided above for the dental fitting and the dental component fully apply to the dental assembly of the invention.

The dental assembly of the invention provides the effects and advantages already described in detail above for the dental fitting of the invention.

The dental component may be, for example, a dental implant or an implant analogue, e.g., for use in a dental laboratory.

For the case of a multi-piece abutment, e.g., a two-piece abutment, the dental fitting may be one piece of the abutment and the dental component may be another piece of the abutment. In this case, the one piece of the abutment comprises the retention element and can be attached to the other piece of the abutment through the retention element. Alternatively or in addition thereto, a base piece or unit of the multi-piece abutment may comprise the retention element and be attached to a dental implant by the retention element.

The dental fitting may be made of the same material as the dental component or of a different material.

The dental component has at least one cavity formed in a coronal portion thereof for receiving the at least one projection or protrusion of the attachment portion of the retention element.

The dental component, such as a dental implant, may have a threaded bore for receiving a threaded portion of a screw, such as that described above, and the dental fitting may have a through hole extending through the dental fitting in the longitudinal direction of the dental fitting, as has been detailed above. The through hole may have a screw seat for retaining a head of the screw. In this way, the dental fitting can be fixed to the dental component in a reversible manner by means of the screw.

Moreover, the invention provides a method of attaching the dental fitting according to the invention to a dental component, such as a dental implant.

The method of the invention may be a method of attaching the dental fitting according to the invention to a dental component, such as a dental implant, outside (or inside) a human or animal body. For example, the dental fitting of the invention may be attached to a dental component in a dental laboratory, e.g., using a jaw bone model.

The method of the invention of attaching the dental fitting to a dental component provides the effects and advantages already described in detail above for the dental fitting of the invention.

### BRIEF DESCRIPTION OF THE DRAWINGS

Hereinafter, non-limiting examples of the invention are explained with reference to the drawings, in which:

FIG. 1 shows a dental fitting according to a first embodiment of the present invention, wherein FIG. 1(a) is a perspective view of an apical portion of the dental fitting, FIG. 1(b) is a perspective view of the entire dental fitting, FIG. 1(c) is a side view of the dental fitting, and FIG. 1(d) is a cross-sectional view taken along the line A-A in FIG. 1(c);

FIG. 2 shows a dental assembly according to an embodiment of the present invention, comprising the dental fitting shown in FIG. 1 and a dental implant, wherein FIG. 2(a) is, a perspective view of the dental assembly, and FIG. 2(b) is a side view of the dental assembly;

FIG. 3 shows the dental assembly according to the embodiment of the present invention, wherein FIG. 3(a) is a cross-sectional view of the dental assembly, showing the dental assembly prior to the attachment of the dental fitting to the dental implant, FIG. 3(b) is a cross-sectional view of the dental assembly, showing the dental assembly in the assembled state, and FIG. 3(c) is a cross-sectional view of the dental assembly, illustrating a state in which the dental fitting is fixed to the dental implant by a screw;

FIG. 4 shows dental fittings according to second and third embodiments of the present invention, wherein FIG. 4(a) is a perspective view of the dental fitting according to the second embodiment, FIG. 4(b) is a perspective view of the dental fitting according to the third embodiment, FIG. 4(c) is a top view of the retention element of the dental fitting according to the second embodiment, and FIG. 4(d) is a top view of the retention element of the dental fitting according to the third embodiment;

FIG. 5 shows dental fittings according to fourth and fifth embodiments of the present invention, wherein FIG. 5(a) is a perspective view of the dental fitting according to the fourth embodiment, FIG. 5(b) is a perspective view of the dental fitting according to the fifth embodiment, FIG. 5(c) is a top view of the retention element of the dental fitting according to the fourth embodiment, and FIG. 5(d) is a top view of the retention element of the dental fitting according to the fifth embodiment;

FIG. 6 shows a dental fitting according to a sixth embodiment of the present invention, wherein FIG. 6(a) is a perspective view of an apical portion of the dental fitting, FIG. 6(b) is a bottom view of the dental fitting, FIG. 6(c) is a cross-sectional view taken along the line B-B in FIG. 6(b), and FIG. 6(d) is a top view of the retention element of the dental fitting;

FIG. 7 shows a dental fitting according to a seventh embodiment of the present invention, wherein FIG. 7(a) is a perspective view of an apical portion of the dental fitting, FIG. 7(b) is a bottom view of the dental fitting, FIG. 7(c) is a cross-sectional view taken along the line B-B in FIG. 7(b), and FIG. 7(d) is a top view of the retention element of the dental fitting; and

FIG. 8 shows a dental fitting according to an eighth embodiment of the present invention, wherein FIG. 8(a) is a perspective view of an apical portion of the dental fitting, FIG. 8(b) is a bottom view of the dental fitting, FIG. 8(c) is a cross-sectional view taken along the line B-B in FIG. 8(b), and FIG. 8(d) is a top view of the retention element of the dental fitting.

### DETAILED DESCRIPTION OF PREFERRED EMBODIMENTS

Preferred embodiments of the present invention will now be described with reference to the accompanying drawings.

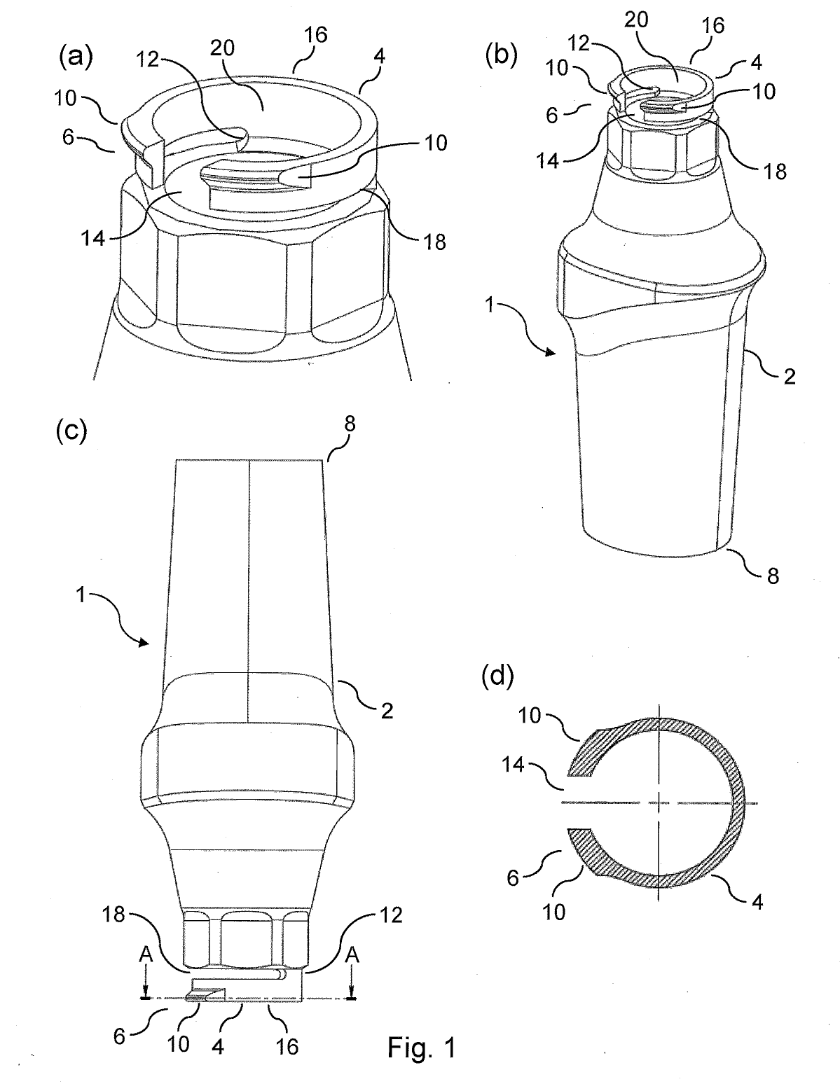

FIG. 1 shows a dental fitting 1 according to a first embodiment of the present invention.

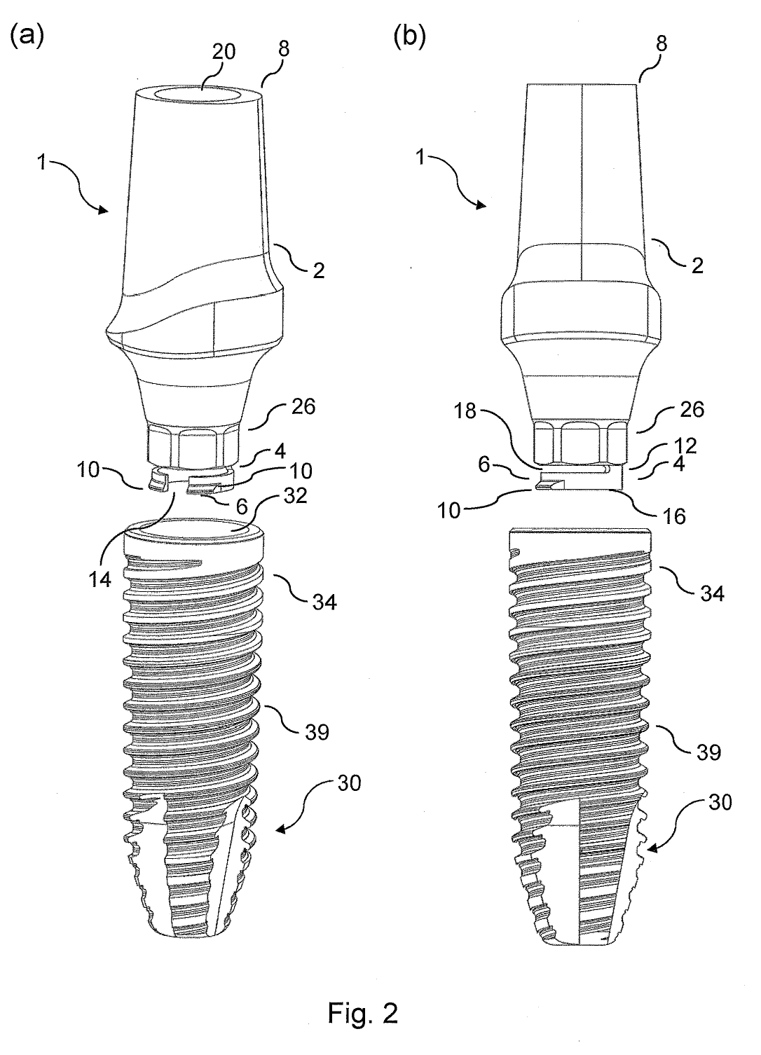

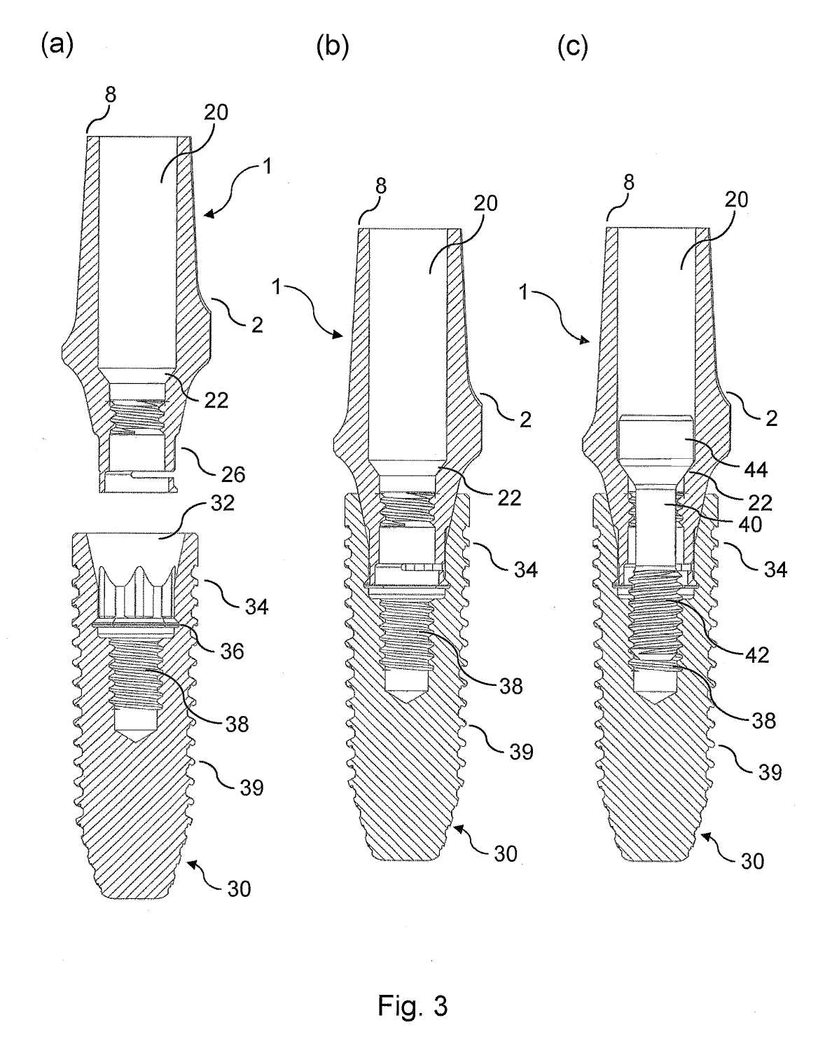

The dental fitting 1 is an abutment, namely a single-piece abutment, attachable to a dental component, such as a dental implant (see FIGS. 2 and 3). The dental fitting 1 comprises a main body 2 and a retention element 4 provided apically to the main body 2, as is shown in FIGS. 1(b) and (c). The retention element 4 comprises an attachment portion 6 for attaching the dental fitting 1 to the dental component (see, e.g., FIG. 1(a)). The retention element 4 is elastically deformable in all directions perpendicular to the direction from the attachment portion 6 towards a coronal end 8 of the main body 2, i.e., along all transverse directions of the retention element 4.

The attachment portion 6 comprises two projections 10, each extending in plural directions substantially perpendicular to the direction from the attachment portion 6 towards the coronal end 8 of the main body 2, i.e., along plural transverse directions of the retention element 4.

Each of the two projections 10 has a coronal surface which is inclined relative to the direction from the coronal end 8 of the main body 2 towards the attachment portion 6 at an angle of less than 90°, as is shown in FIGS. 1(a) and (c).

The retention element 4 is integrally formed with the main, body 2. Specifically, the retention element 4 is integrally formed with the main body 2 through a single link portion 12 arranged between the retention element 4 and the main body 2 in the longitudinal direction of the retention element 4 (see FIGS. 1(a) to (c)). The link portion 12 extends along only a part of the retention element 4 in a circumferential direction of the retention element 4, as is schematically shown, for example, in FIGS. 1(a) and (c).

The dental fitting 1 is made of a metal, such as titanium or a titanium alloy. The dental fitting 1 may be manufactured, for example, by milling, such as CNC milling. In particular, the dental fitting 1 may be formed from a single piece of titanium or a titanium alloy by milling, e.g., CNC milling.

The retention element 4 has a substantially cylindrical shape with a substantially circular cross-section perpendicular to the longitudinal direction of the retention element 4 (see FIGS. 1(a) and (d)). The retention element 4 is formed as a hollow, tubular body and has a cut-out portion 14 extending from an apical end 16 of the retention element 4 to a coronal end 18 of the retention element 4. The cut-out portion 14 penetrates an outer wall of the retention element 4, as is schematically shown in FIGS. 1(a), (b) and (d). The retention element 4 thus has an open ring shape in a cross-section perpendicular to the direction from the attachment portion 6 towards the coronal end 8 of the main body 2.

The cut-out portion 14 formed in the outer wall of the retention element 4 renders the entire retention element 4 elastically deformable in all directions perpendicular to the direction from the attachment portion 6 towards the coronal end 8 of the main body 2, i.e., in all the transverse directions of the retention element 4. In particular, the retention element 4 can be elastically compressed in the transverse directions thereof when attaching the dental fitting 1 to the dental component, such as a dental implant (e.g., FIG. 3).

The projections 10 of the attachment portion 6 allow for the dental fitting 1 to be attached to the dental component by snap fit, as will be explained in detail below with reference to FIG. 3.

As is shown in FIGS. 1(a), (b) and (d), the projections 10 of the attachment portion 6 are provided adjacent to the cut-out portion 14. In this way, a particularly reliable and efficient snap fit of the attachment portion 6 and the dental component can be ensured.

Further, as is also shown in FIG. 1(d), the projections 10 have the same protruding heights from an outer surface of the remainder of the retention element 4, i.e., heights from this outer surface in transverse directions of the retention element 4.

The link portion 12 is arranged opposite to the cut-out portion 14 in the radial direction of the retention element 4 (see FIGS. 1(a) and (b)). Further, the link portion 12 is arranged opposite to the two projections 10 of the attachment portion 6 in the radial direction of the retention element 4.

The dental fitting 1 further comprises a through hole 20 extending through the dental fitting 1 in the direction from a coronal end of the dental fitting 1 to an apical end of the dental fitting 1, as is schematically shown in FIGS. 1(a) and (b) and will be further detailed below with reference to FIG. 3.

FIGS. 2 and 3 show a dental assembly according to an embodiment of the present invention, comprising the dental fitting 1 shown in FIG. 1 and a dental implant 30 as the dental component.

The dental implant 30 is made of a metal, for example, titanium, a titanium alloy.

As is shown in FIGS. 3(a) to (c), the through hole 20 of the dental fitting 1 comprises a screw seat 22 for resting a screw head thereon.

The dental implant 30 has a recess 32 formed at a coronal portion 34 of the implant 30, for receiving an apical portion 26 of the dental fitting 1 including the retention element 4 (see FIGS. 2(a) and 3(a)). The coronal portion 34 of the implant 30 is formed with an annular cavity 36 (see FIG. 3(a)) for receiving the projections 10 of the attachment portion 6 of the retention element 4, as is shown in FIGS. 3(h) and (c). Therefore, the attachment portion 6 of the retention element 4 can be securely held within the coronal portion 34 of the implant 30 by snap fit.

The recess 32 may further define an anti-rotation portion located coronal to (or above, when considering FIG. 3) the cavity 36 and a conical portion located coronal to (or above, when considering FIG. 3) the anti-rotation portion. Fitting 1 may have portions matching the above described portions of recess 30.

Further, the dental implant 30 has a threaded bore 38 extending below the recess 32 in the apical direction of the implant 30, as is shown in FIGS. 3(a) to (c). Moreover, the dental implant 30 has an outer threaded portion 39 for screwing the implant 30 into a patient's jaw bone (see FIGS. 2 and 3).

When attaching the dental fitting 1 to the dental implant 30, the apical portion 26 of the dental fitting 1 is inserted into the recess 32 of the implant 30 so that the protrusions 10 of the attachment portion 6 of the retention element 4 are received in the annular cavity 36 formed in the coronal portion 34 of the implant 30. Hence, the retention element 4 is securely held within this coronal portion 34 by snap fit, thus reliably attaching the dental fitting 1 to the implant 30.

In the process of attaching the dental fitting 1 to the implant 30, the retention element 4 is first elastically deformed, i.e., elastically compressed, in the transverse directions thereof upon insertion of the retention element 4 into the recess 32, and subsequently restored to its initial shape, once the projections 10 are received in the annular cavity 36. This “snap in” process of the projections 10 provides an audible and tactile feedback to the user of the dental assembly, such as a clinician or a technician, e.g., in a dental laboratory, indicating that the dental fitting 1 is properly seated in the implant 30 (see FIG. 3(b)).

After the dental fitting 1 has been properly attached to the dental implant 30 via the retention element 4, the dental fitting 1 and the implant 30 are securely fixed in the attached state by inserting a screw 40 through the coronal opening of the through hole 20 of the dental fitting 1 and screwing the screw 40 into the threaded bore 38 of the implant 30. In the fully inserted state of the screw 40, which is illustrated in FIG. 3(c), a lower threaded portion 42 of the screw 40 is received within the threaded bore 38 of the implant 30 and a screw head 44 of the screw 40 rests on the screw seat 22 of the through hole 20 of the dental fitting 1, thereby firmly holding the dental fitting 1 and the implant 30 in their relative positions.

In the manner detailed above, the dental fitting 1 can be fixed to an implant placed in a patient's jaw bone. Specifically, the implant 30 can be screwed into the patient's jaw bone by means of the outer threaded portion 39 of the implant 30. Once the implant 30 is osseointegrated in the jaw bone, or immediately after implant placement, the dental fitting 1 is fixed to the implant 30 through the retention element 4 and the screw 40, as has been detailed above.

Further, the dental fitting 1 may be attached to a dental component, such as the dental implant 30, outside a human or animal body, e.g., in a dental laboratory. In particular, in the manner detailed above, the dental fitting 1 can be fixed to a jaw bone model in the dental laboratory, e.g., using an implant analogue instead of the implant 30.

While the dental assembly according to the embodiment of the present invention detailed above comprises a single-piece abutment as the dental fitting and a dental implant as the dental component, the dental fitting and/or the dental component may be various other elements, as has been explained in detail above.

In particular, the dental fitting may be, for example, a multi-piece abutment, a scan abutment, a temporary abutment, an abutment position locator, an impression taking component, such as an open or closed tray impression post or an impression coping, e.g., a screw-less impression coping, an intra-oral scanning or desk top scanning locator, a healing cap, a temporary restoration or a final restoration.

The dental component may be, for example, an implant analogue, e.g., for use in a dental laboratory, as has been explained in detail above.

For the case of a multi-piece abutment, e.g., a two-piece abutment, the dental fitting may be one piece of the abutment and the dental component may be another piece of the abutment. In this case, the one piece of the abutment comprises the retention element and can be attached to the other piece of the abutment through the retention element. Alternatively or in addition thereto, a base piece or unit of the multi-piece abutment may comprise the retention element and be attached to a dental implant by the retention element.

If a dental fitting and a dental component such as those given above are used instead of the dental fitting 1 and the dental implant 30, these elements are attached to each other through the retention element substantially in the same manner as detailed above for the case of the dental fitting 1 and the dental implant 30.

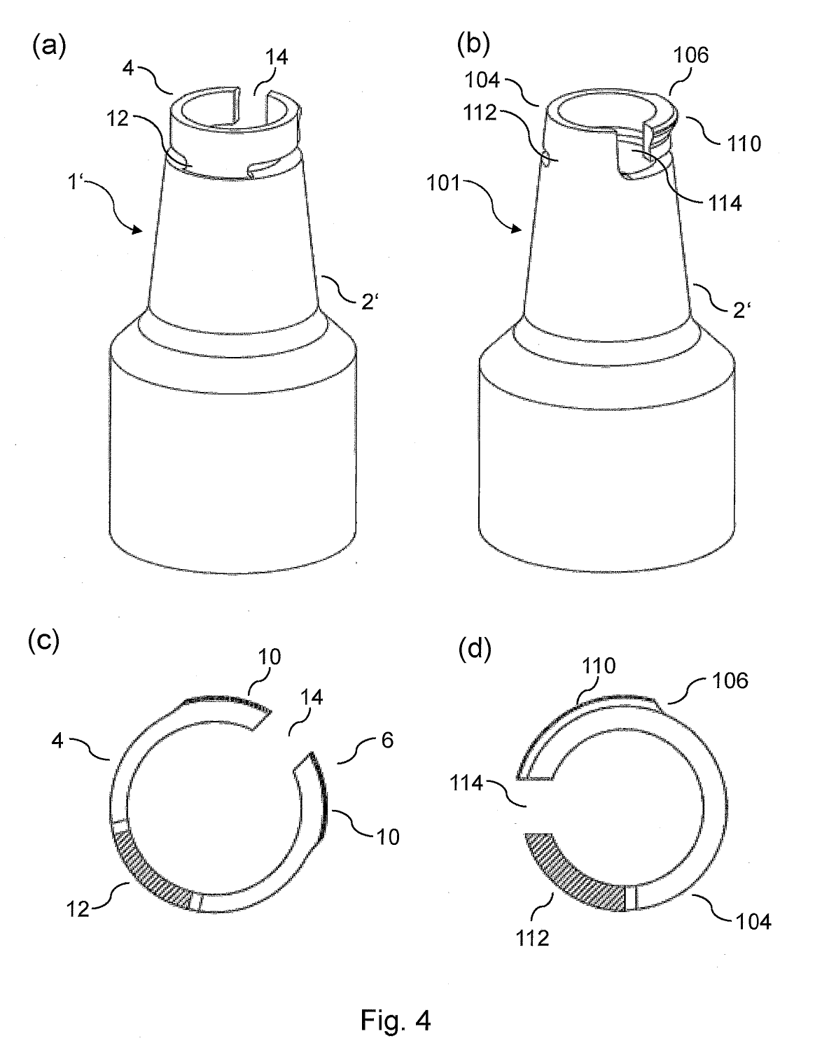

FIG. 4 shows dental fittings according to second and third embodiments of the present invention. The dental fittings according to the second and third embodiments are single-piece abutments.

The dental fitting 1′ according to the second embodiment shown in FIGS. 4(a) and (c) differs from the dental fitting 1 according to the first embodiment in the configuration of the main body 2′ (see FIGS. 1(b) and 4(a)). The retention element 4 of the dental fitting 1′ is substantially identical to that of the dental fitting 1. Hence, the same reference signs are used for the retention element 4 and a repeated detailed description thereof is omitted.

The dental fitting 1′ can be attached to a dental component, e.g., a dental implant, such as the dental implant 30, in the same manner as detailed above for the dental fitting 1.

The dental fitting 101 according to the third embodiment shown in FIGS. 4(b) and (d) differs from the dental fitting 1′ according to the second embodiment in the configuration of the retention element 104. The main body 2′ of the dental fitting 101 is the same as the main body 2′ of the dental fitting 1′. Hence, the same reference sign is used for the main body 2′.

The retention element 104 comprises an attachment portion 106 for attaching the dental fitting 101 to a dental component. The retention element 104 is elastically deformable in all transverse directions of the retention element 104. The attachment portion 106 comprises a single projection 110, extending in plural transverse directions of the retention element 104.

The single projection 110 has a coronal surface which is inclined relative to the direction from the coronal end of the main body 2′ towards the attachment portion 106 at an angle of less than 90°, as is shown in FIG. 4(b).

The retention element 104 is integrally formed with the main body 2′ through a single link portion 112 arranged between the retention element 104 and the main body 2′ in the longitudinal direction of the retention element 104 (see FIG. 4(b)). The link portion 112 extends along only a part of the retention element 104 in a circumferential direction of the retention element 104, as is schematically shown in FIGS. 4(b) and (d).

The retention element 104 has a substantially cylindrical shape with a substantially circular cross-section perpendicular to the longitudinal direction of the retention element 104 (see FIG. 4(d)). The retention element 104 is formed as a hollow, tubular body and has a cut-out portion 114 extending from an apical end of the retention element 104 to a coronal end of the retention element 104. The cut-out portion 114 penetrates an outer wall of the retention element 104, as is schematically shown in FIGS. 4(b) and (d). The retention element 104 thus has an open ring shape in a cross-section perpendicular to the direction from the attachment portion 106 towards the coronal end of the main body 2′.

The single projection 110 of the attachment portion 106 is provided adjacent to the cut-out portion 114 in the circumferential direction of the retention element 104.

The link portion 112 is arranged adjacent to the cut-out portion 114 in the circumferential direction of the retention element 104 (see FIG. 4(d)). Further, the link portion 112 is arranged opposite to the projection 110 of the attachment portion 106 in the radial direction of the retention element 104.

The dental fitting 101 can be attached to a dental component, e.g., a dental implant, such as the dental implant 30, in the same manner as detailed above for the dental fitting 1.

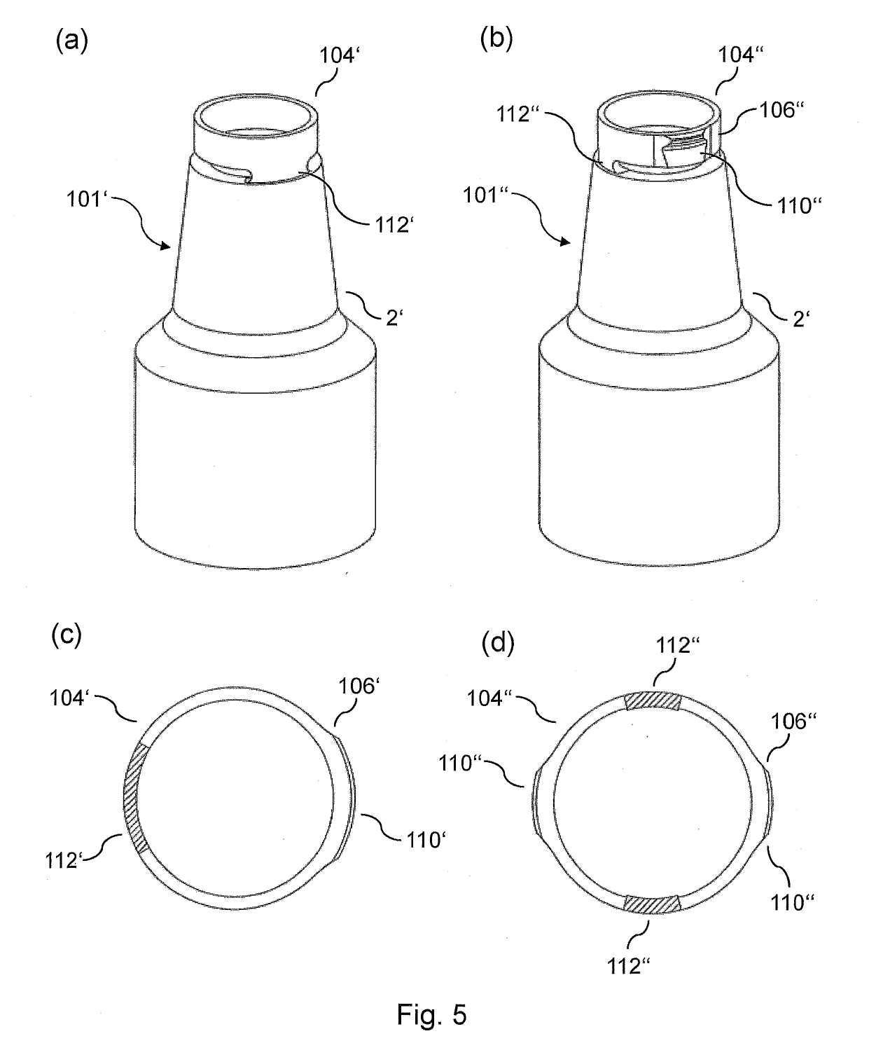

FIG. 5 shows dental fittings according to fourth and fifth embodiments of the present invention. The dental fittings according to the fourth and fifth embodiments are single-piece abutments.

The dental fitting 101′ according to the fourth embodiment shown in FIGS. 5(a) and (c) differs from the dental fitting 1′ according to the second embodiment and the dental fitting 101 according to the third embodiment in the configuration of the retention element 104′. The main body 2′ of the dental fitting 101′ is the same as the main body 2′ of the dental fittings 1′ and 101. Hence, the same reference sign is used for the main body 2′.

The retention element 104′ comprises an attachment portion 106′ for attaching the dental fitting 101′ to a dental component. The retention element 104′ is elastically deformable in all transverse directions of the retention element 104′.

The retention element 104′ has a substantially cylindrical shape with a substantially circular cross-section perpendicular to the longitudinal direction of the retention element 104′ (see FIG. 5(c)).

The retention element 104′ is formed as a hollow, tubular body and has a closed ring shape or closed annular shape, i.e., the shape of a ring without an opening in the circumference thereof. The elastic deformability of the retention element 104′ in all transverse directions thereof is provided by appropriately choosing the material and the wall thickness of the retention element 104′.

The attachment portion 106′ comprises a single projection 110′, extending in plural transverse directions of the retention element 104′.

The single projection 110′ has a coronal surface which is inclined relative to the direction from the coronal end of the main body 2′ towards the attachment portion 106′ at an angle of less than 90°.

The retention element 104′ is integrally formed with the main body 2′ through a single link portion 112′ arranged between the retention element 104′ and the main body 2′ in the longitudinal direction of the retention element 104′ (see FIG. 5(a)). The link portion 112′ extends along only a part of the retention element 104′ in the circumferential direction of the retention element 104′, as is schematically shown in FIGS. 5(a) and (c).

The link portion 112′ is arranged opposite to the projection 110′ of the attachment portion 106′ in the radial direction of the retention element 104′.

The dental fitting 101′ can be attached to a dental component, e.g., a dental implant, such as the dental implant 30, in the same manner as detailed above for the dental fitting 1.

The dental fitting 101″ according to the fifth embodiment shown in FIGS. 5(b) and (d) differs from the dental fittings 1′, 101 and 101′ according to the second to fourth embodiments in the configuration of the retention element 104″. The main body 2′ of the dental fitting 101″ is the same as the main body 2′ of the dental fittings 1′, 101 and 101′. Hence, the same reference sign is used for the main body 2′.

The retention element 104″ comprises an attachment portion 106″ for attaching the dental fitting 101″ to a dental component. The retention element 104″ is elastically deformable in all transverse directions of the retention element 104″.

The retention element 104″ has a substantially cylindrical shape with a substantially circular cross-section perpendicular to the longitudinal direction of the retention element 104″ (see FIG. 5(d)).

The retention element 104″ is formed as a hollow, tubular body and has a closed ring shape or closed annular shape, i.e., the shape of a ring without an opening in the circumference thereof. The elastic deformability of the retention element 104″ in all transverse directions thereof is provided by appropriately choosing the material and the wall thickness of the retention element 104″.

The attachment portion 106″ comprises two projections 110″, each extending in plural transverse directions of the retention element 104″. The two projections 110″ are arranged opposite to each other in the radial direction of the retention element 104″ (see FIG. 5(d)).

Each of the two projections 110″ has a coronal surface which is inclined relative to the direction from the coronal end of the main body 2′ towards the attachment portion 106″ at an angle of less than 90°, as is shown in FIG. 5(b).

The retention element 104″ is integrally formed with the main body 2′ through two link portions 112″ arranged between the retention element 104″ and the main body 2′ in the longitudinal direction of the retention element 104 (see FIG. 5(b)). Each of the two link portions 112″ extends along only a part of the retention element 104″ in the circumferential direction of the retention element 104″, as is schematically shown in FIG. 5(d).

The two link portions 112″ are arranged opposite to each other in the radial direction of the retention element 104″.

The dental fitting 101″ can be attached to a dental component, e.g., a dental implant, such as the dental implant 30, in the same manner as detailed above for the dental fitting 1.

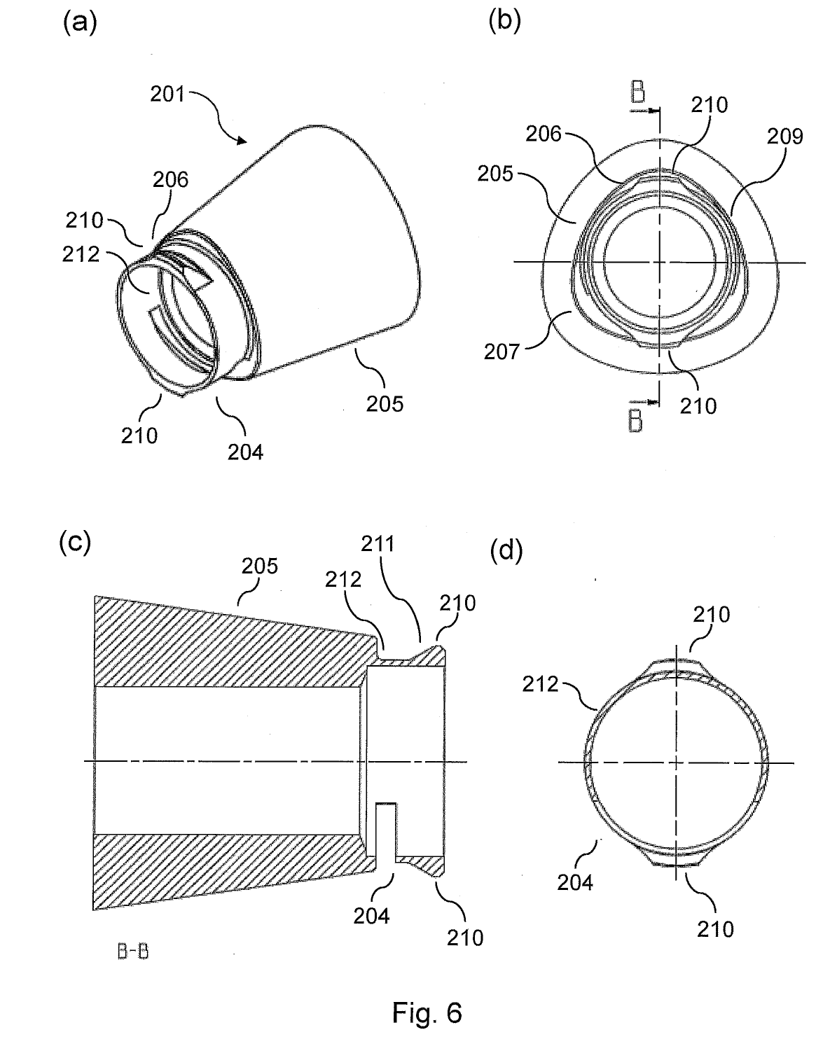

FIG. 6 shows a dental fitting according to a sixth embodiment of the present invention.

The dental fitting 201 according to the sixth embodiment shown in FIGS. 6(a) to (d) differs from the dental fitting 101′ according to the fourth embodiment and the dental fitting 101″ according to the fifth embodiment in the configuration of the retention element 204 and in the configuration of the apical portion 205 of the main body (see FIG. 6(a)). The remainder of the main body of the dental fitting 201 can be the same as the remainder of the main body 2′ of the dental fittings 1′ and 101.

The retention element 204 comprises an attachment portion 206 for attaching the dental fitting 201 to a dental component. The retention element 204 can be elastically deformable in all transverse directions of the retention element 204.

The retention element 204 has a substantially cylindrical shape with a substantially circular cross-section perpendicular to the longitudinal direction of the retention element 204 (see FIGS. 6(b) and (d)).

The retention element 204 is formed as a hollow, tubular body and has a closed ring shape or closed annular shape, i.e., the shape of a ring without an opening in the circumference thereof. The elastic deformability of the retention element 204 in all transverse directions thereof is provided by appropriately choosing the material and the wall thickness of the retention element 204.

The attachment portion 206 comprises two projections 210, each extending in plural transverse directions of the retention element 204. The two projections 210 are arranged opposite to each other in the radial direction of the retention element 204 (see FIGS. 6(a), (b) and (d)).

Each of the two projections 210 has a coronal surface 211 which is inclined relative to the direction from the coronal end of the main body towards the attachment portion 206 at an angle of less than 90°, as is shown in FIGS. 6(a) and (c).

The retention element 204 is integrally formed with the main body through a single link portion 212 arranged between the retention element 204 and the main body in the longitudinal direction of the retention element 204 (see FIGS. 6(a) and (c)). The link portion 212 extends along only a part of the retention element 204 in the circumferential direction of the retention element 204, as is schematically shown by the hatched area in FIG. 6(d).

The link portion 212 is configured so as to be arranged at the position of only one of the two projections 210, as is shown in FIG. 6(d).

Due to the above arrangement of the link portion 212, a lower force is required for radially displacing, in a radially inward direction, one of the two projections 210 (the lower projection 210 in FIGS. 6(b) and (d)) than for radially displacing, in a radially inward direction, the other of the two projections 210 (the upper projection 210 in FIGS. 6(b) and (d)). The other of the two projections 210 can thus particularly reliably act as a guide projection, guiding the dental fitting 201 when attaching the fitting 201 to the dental component.

The apical portion 205 of the main body has a trioval cross-section perpendicular to the direction from the attachment portion 206 towards the coronal end of the main body. The trioval cross-section has three radial maxima 207 and three radial minima 209, as is shown in FIG. 6(b).

The one of the two projections 210 (the lower projection 210 in FIG. 6(b)) is arranged at a radial minimum 209 of the trioval cross-section. Further, this projection 210 has a radial extension which is larger than the radial extension of the minimum 209. Thus, the projection 210 is arranged so as to radially extend beyond the minimum 209 (see FIG. 6(b)).

The other of the two projections 210 (the upper projection 210 in FIG. 6(b)) is arranged at a radial maximum 207 of the trioval cross-section. Further, this projection 210 has a radial extension which is smaller than the radial extension of the maximum 207. Hence, the projection 210 is arranged radially inward from the maximum 207 (see FIG. 6(b)).

The projection 210 arranged at the radial minimum 209 is the projection which for which a lower force is required in order to achieve a radial displacement thereof.

The dental fitting 201 can be attached to a dental component, e.g., a dental implant, such as the dental implant 30, in the same manner as detailed above for the dental fitting 1.

In this attachment process, the one of the two projections 210 comes into contact with the inner wall of the dental component before the other of the two projections 210, thus helping to guide and align the dental fitting 201 in the attachment process.

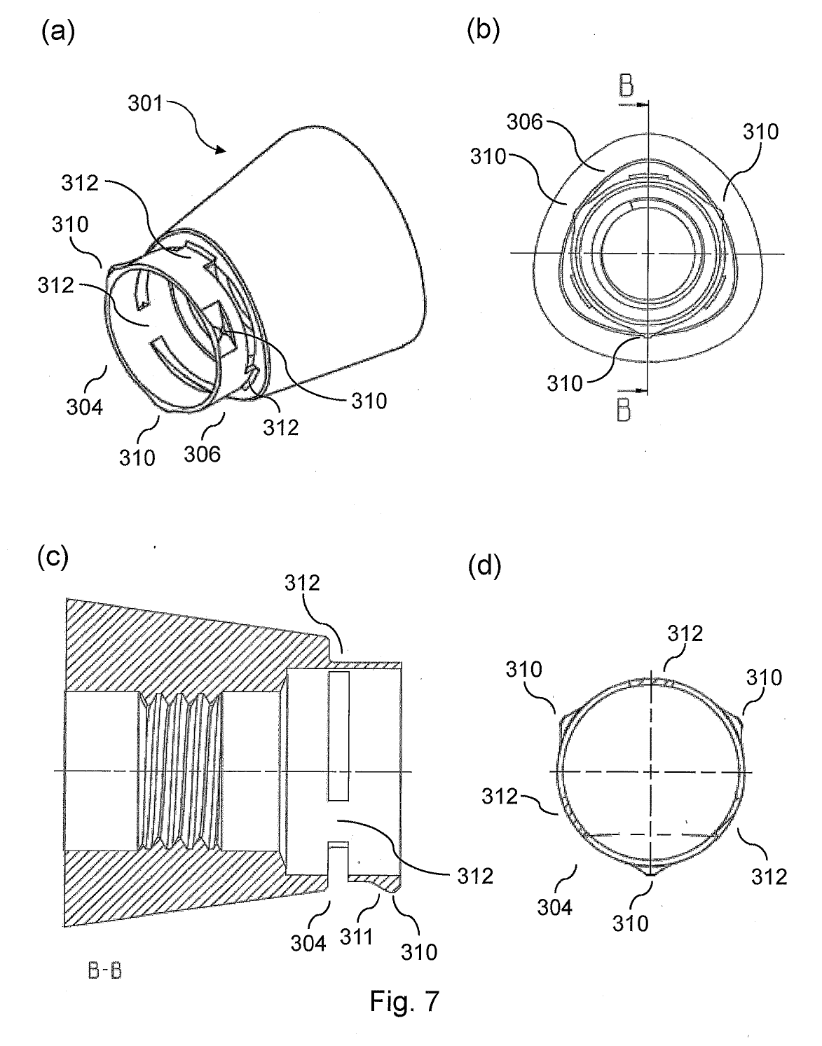

FIG. 7 shows a dental fitting according to a seventh embodiment of the present invention.

The dental fitting 301 according to the seventh embodiment shown in FIGS. 7(a) to (d) differs from the dental fitting 201 according to the sixth embodiment substantially only in the configuration of the retention element 304. The outer structure of the main body of the dental fitting 301 is the same as the outer structure of the main body of the dental fitting 201. Hence, a detailed description thereof is omitted.

The retention element 304 comprises an attachment portion 306 for attaching the dental fitting 301 to a dental component. The retention element 304 is elastically deformable in all transverse directions of the retention element 304.

The retention element 304 has a substantially cylindrical shape with a substantially circular cross-section perpendicular to the longitudinal direction of the retention element 304 (see FIGS. 7(b) and (d)).

The retention element 304 is formed as a hollow, tubular body and has a closed ring shape or closed annular shape, i.e., the shape of a ring without an opening in the circumference thereof. The elastic deformability of the retention element 304 in all transverse directions thereof is provided by appropriately choosing the material and the wall thickness of the retention element 304.

The attachment portion 306 comprises three projections 310, each extending in plural transverse directions of the retention element 304. The three projections 310 are equidistantly spaced from each other in the circumferential direction of the retention element 304 (see FIGS. 7(a), (b) and (d)).

Each of the three projections 310 has a coronal surface 311 which is inclined relative to the direction from the coronal end of the main body towards the attachment portion 306 at an angle of less than 90°, as is shown in FIG. 7(c).

The retention element 304 is integrally formed with the main body through three link portions 312 arranged between the retention element 304 and the main body in the longitudinal direction of the retention element 304 (see FIGS. 7(a) and (c)). Each of the three link portions 312 extends along only a part of the retention element 304 in the circumferential direction of the retention element 304, as is schematically shown by the hatched areas in FIG. 7(d).

The three link portions 312 are equidistantly spaced from each other in the circumferential direction of the retention element 304 (see FIGS. 7(a), (b) and (d)).

The three link portions 312 are arranged so that each of the link portions 312 is arranged between two respective ones of the projections 310 in the circumferential direction of the retention element 304.

As has been indicated above, the apical portion of the main body of the dental fitting 301 has the same trioval cross-section as the apical portion 205 of the main body of the dental fitting 201. This trioval cross-section has three radial maxima and three radial minima, as is shown in FIG. 7(b).

Each of the three projections 310 is arranged at a radial minimum of the trioval cross-section and each of the three link portions 312 is arranged at a radial maximum of the trioval cross-section (see FIG. 7(b)).

The dental fitting 301 can be attached to a dental component, e.g., a dental implant, such as the dental implant 30, in the same manner as detailed above for the dental fitting 1.

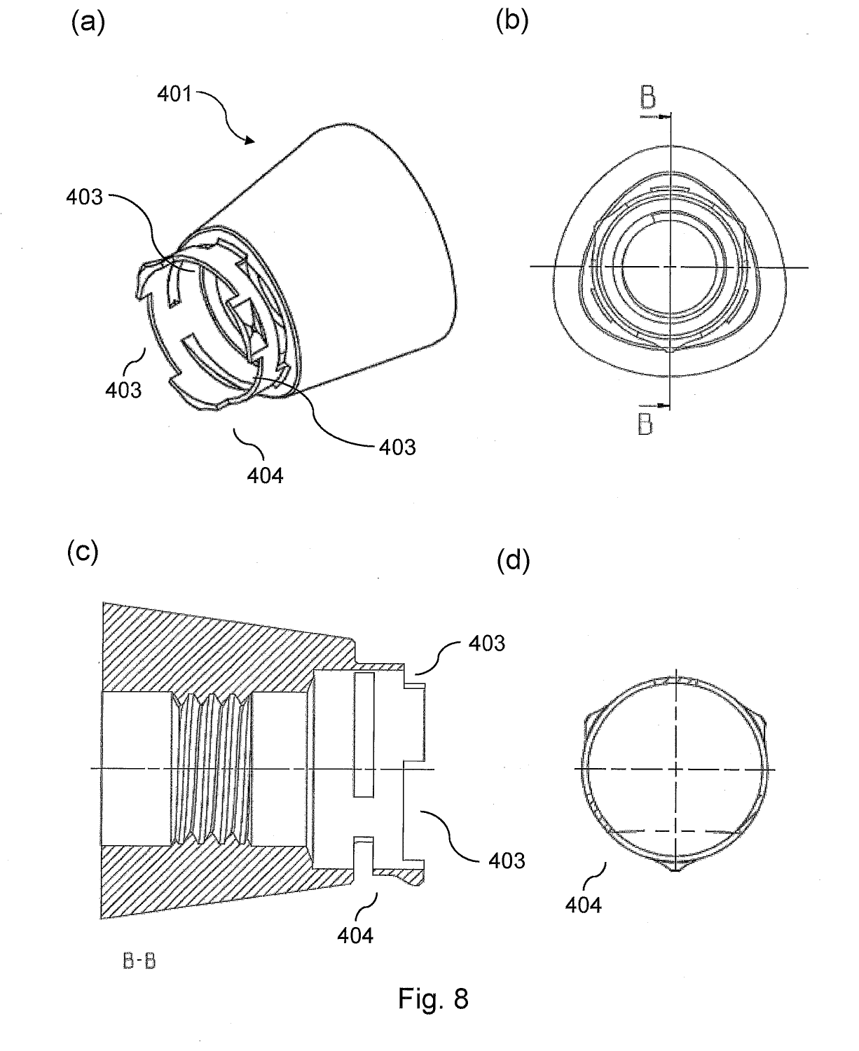

FIG. 8 shows a dental fitting according to an eighth embodiment of the present invention. The dental fitting according to the eighth embodiment is a single-piece abutment.

The dental fitting 401 according to the eighth embodiment shown in FIGS. 8(a) to (d) differs from the dental fitting 301 according to the seventh embodiment only in the configuration of the retention element 404. The main body of the dental fitting 401 has the same configuration as the main body of the dental fitting 301. Hence, a detailed description thereof is omitted.

The retention element 404 of the dental fitting 401 differs from the retention element 304 of the dental fitting 301 only in that three recesses 403 are provided in the wall of the retention element 404 (see FIGS. 8(a) and (c)). The remainder of the retention element 404 of the dental fitting 401 is identical to that of the retention element 304 of the dental fitting 301. Therefore, a detailed description thereof is omitted.

Each of the three recesses 403 is configured so that it fully penetrates the wall of the retention element 404 and extends only along a part of the length of the retention element 404 in the longitudinal direction of the retention element 404.

The three recesses 403 are equidistantly spaced from each other in the circumferential direction of the retention element 404 (see FIG. 8(a)).

Each of the three recesses 403 is arranged between two respective ones of the projections in the circumferential direction of the retention element 404. Each of the three recesses 403 is arranged at the position of a respective one of the link portions (see FIG. 8(a)).

The three recesses 403 help to control the elastic deformability of the retention element 404 in the transverse directions thereof.

The dental fitting 401 can be attached to a dental component, e.g., a dental implant, such as the dental implant 30, in the same manner as detailed above for the dental fitting 1.

The following numbered paragraphs provide further disclosure of the present invention:

1. A dental fitting (1, 1′, 101, 101′, 101″) attachable to a dental component (30), such as a dental implant, the dental fitting (1, 1′, 101, 101′, 101″) comprising:
a main body (2, 2′); and
a retention element (4, 104, 104′, 104″) provided apically to the main body (2, 2′); wherein
the retention element (4, 104, 104′, 104″) comprises an attachment portion (6, 106, 106′, 106″) for attaching the dental fitting (1, 1′, 101, 101′, 101″) to the dental component (30),
the retention element (4, 104, 104′, 104″) is elastically deformable at least in all directions perpendicular to the direction from the attachment portion (6, 106, 106′, 106″) towards a coronal end (8) of the main body (2, 2′),
the attachment portion (6, 106, 106′, 106″) comprises at least one projection (10, 110, 110′, 110″) extending in one or more directions substantially perpendicular to the direction from the attachment portion (6, 106, 106′, 106″) towards the coronal end (8) of the main body (2, 2′), and
the retention element (4, 104, 104′, 104″) is integrally formed with or integrally attached to the main body (2, 2′).
   2. The dental fitting (1, 1′, 101) according to paragraph 1, wherein the retention element (4, 104) has at least one portion extending from an apical end (16) of the retention element (4, 104) to a coronal end (18) of the retention element (4, 104), said at least one portion being more flexible than the remainder of the retention element (4, 104).
   3. The dental fitting (1, 1′, 101) according to paragraph 1 or 2, wherein the retention element (4, 104) has at least one cut-out portion (14, 114) extending from an apical end (16) of the retention element (4, 104) to a coronal end (18) of the retention element (4, 104).
   4. The dental fitting (1, 1′, 101) according to paragraph 3, wherein the retention element (4, 104) is a hollow body and the at least one cut-out portion (14, 114) penetrates an outer wall of the retention element (4, 104).
   5. The dental fitting (1, 1′, 101, 101′, 101″) according to any one of the preceding paragraphs, wherein the retention element (4, 104, 104′, 104″) is integrally formed with or integrally attached to the main body (2, 2′) through one or more link portions (12, 112, 112′, 112″) arranged between the retention element (4, 104, 104′, 104″) and the main body (2, 2′), and each of the one or more link portions (12, 112, 112′, 112″) extends along a part of the retention element (4, 104, 104′, 104″) in a circumferential direction of the retention element (4, 104, 104′, 104″).
   6. The dental fitting (1, 1′, 101) according to paragraph 5 as dependent on paragraph 2, wherein the retention element (4, 104) is integrally formed with or integrally attached to the main body (2, 2′) through a single link portion (12, 112), the retention element (4, 104) has a single portion extending from the apical end (16) of the retention element (4, 104) to the coronal end (18) of the retention element (4, 104), said single portion being more flexible than the remainder of the retention element (4, 104), and the link portion (12, 112) is arranged opposite to said single portion in a radial direction of the retention element (4, 104) or adjacent to said single portion in a circumferential direction of the retention element (4, 104).
   7. The dental fitting (1, 1′, 101) according to paragraph 5 as dependent on paragraph 3 or 4, wherein the retention element (4, 104) is integrally formed with or integrally attached to the main body (2, 2′) through a single link portion (12, 112), the retention element (4, 104) has a single cut-out portion (14, 114) extending from the apical end (16) of the retention element (4, 104) to the coronal end (18) of the retention element (4, 104), and the link portion (12, 112) is arranged opposite to the cut-out portion (14, 114) in a radial direction of the retention element (4, 104) or adjacent to the cut-out portion (14, 114) in a circumferential direction of the retention element (4, 104).
   8. The dental fitting (1′, 1′, 101, 101′) according to any one of paragraphs 5 to 7, wherein the retention element (4, 104, 104′) is integrally formed with or integrally attached to the main body (2, 2′) through a single link portion (12, 112, 112′), and the link portion (12, 112, 112′) is arranged opposite to the at least one projection (10, 110, 110′) of the attachment portion (6, 106, 106′) in a radial direction of the retention element (4, 104, 104′).
   9. The dental fitting (101″) according to paragraph 5, wherein the retention element (104″) is integrally formed with or integrally attached to the main body (2′) through at least two link portions (112″), and the at least two link portions (112″) are arranged opposite to each other in a radial direction of the retention element (104″).
   10. The dental fitting (1, 1′, 101″) according to any one of the preceding paragraphs, wherein the attachment portion (6, 106″) comprises two or more projections (10, 110″), each extending in one or more directions substantially perpendicular to the direction from the attachment portion (6, 106″) towards the coronal end (8) of the main body (2, 2′).
   11. The dental fitting (1, 1′, 101, 101′, 101″) according to any one of the preceding paragraphs, wherein the dental fitting (1, 1′, 101, 101′, 101″) further comprises a through hole (20) extending through the dental fitting (1, 1′, 101, 101′, 101″) in the direction from a coronal end of the dental fitting (1, 1′, 101, 101′, 101″) to an apical end of the dental fitting (1, 1′, 101, 101′, 101″).
   12. The dental fitting (1, 1′, 101, 101′, 101″) according to any one of the preceding paragraphs, wherein the dental fitting (1, 1′, 101, 101′, 101″) has a marking, such as a colour code, and/or the dental fitting (1, 1′, 101, 101′, 101″) further comprises an indication and/or tracking device, such as an RFID tag.
   13. The dental fitting (1, 1′, 101, 101′, 101″) according to any one of the preceding paragraphs, wherein the retention element (4, 104, 104′, 104″) is made of a metal, a polymer or a composite material.
   14. A dental assembly comprising the dental fitting (1, 1′, 101, 101′, 101″) according to any one of the preceding paragraphs and a dental component (30), such as a dental implant.
   15. A method of attaching the dental fitting (1, 1′, 101, 101′, 101″) according to any one of paragraphs 1 to 13 to a dental component (30), such as a dental implant.

1. A dental fitting configured to attach to a dental component, the dental fitting comprising:
a main body; and
a retention element provided apically to the main body; wherein
the retention element comprises an attachment portion configured to attach the dental fitting to the dental component,
the retention element has a closed ring shape or an open ring shape in a cross-section perpendicular to the direction from the attachment portion towards a coronal end of the main body,
the attachment portion comprises at least one projection extending in one or more directions substantially perpendicular to the direction from the attachment portion towards the coronal end of the main body,
the at least one projection has a coronal surface which is inclined relative to the direction from the coronal end of the main body towards the attachment portion at an angle of less than 90°, and
the retention element is integrally formed with or integrally attached to the main body.

2. A dental fitting configured to attach to a dental component (30), the dental fitting comprising:
a main body; and
a retention element provided apically to the main body; wherein
the retention element comprises an attachment portion for attaching the dental fitting to the dental component, the retention element has a closed ring shape or an open ring shape in a cross-section perpendicular to the direction from the attachment portion towards a coronal end of the main body,
the attachment portion comprises at least two projections, each extending in one or more directions substantially perpendicular to the direction from the attachment portion towards the coronal end of the main body,
the at least two projections are spaced from each other in the circumferential direction of the retention element, and
the retention element is integrally formed with or integrally attached to the main body.

3. The dental fitting according to claim 2, wherein the retention element is configured so that a lower force is required for radially displacing one of the at least two projections than for radially displacing the other of the at least two projections.

4. The dental fitting according to claim 1, wherein the retention element is elastically deformable at least in all directions perpendicular to the direction from the attachment portion towards the coronal end of the main body.

5. The dental fitting according to claim 1, wherein the retention element has a wall thickness in the range of 0.02 mm to 0.50 mm.

6. The dental fitting according to claim 1, wherein the retention element is funned of a material having a Young's modulus in the range of 95 to 120 GPa.

7. The dental fitting according to claim 1, wherein the coronal surface of the at least one projection or the at least two projections is inclined relative to the direction from the coronal end of the main body towards the attachment portion at an angle of 25° or more.

8. The dental fitting according to claim 1, wherein the coronal surface of the at least one projection or the at least two projections is inclined relative to the direction from the coronal end of the main body towards the attachment portion at an angle of not more than 80°.

9. The dental fitting according to claim 1, wherein the retention element has at least one portion extending from an apical end of the retention element to a coronal end of the retention element, said at least one portion being more flexible than the remainder of the retention element.

10. The dental fitting according to claim 1, wherein the retention element has at least one cut-out portion extending from an apical end of the retention element to a coronal end of the retention element.

11. The dental fitting according to claim 10, wherein the retention element is a hollow body and at least one cut-out portion penetrates an outer wall of the retention element.

12. The dental fitting according to claim 1, wherein the retention element is integrally formed with or integrally attached to the main body through one or more link portions arranged between the retention element and the main body, and each of the one or more link portions extends along a part of the retention element in a circumferential direction of the retention element.

13. The dental fitting according to claim 9, wherein the retention element is integrally formed with or integrally attached to the main body through one or more link portions arranged between the retention element and the main body, and each of the one or more link portions extends along a part of the retention element in a circumferential direction of the retention element; wherein the retention element is integrally formed with or integrally attached to the main body through a single link portion, the retention element has a single portion extending from the apical end of the retention element to the coronal end of the retention element, said single portion being more flexible than the remainder of the retention element, and the link portion is arranged opposite to said single portion in a radial direction of the retention element or adjacent to said single portion in a circumferential direction of the retention element.

14. The dental fitting according to claim 10, wherein the retention element is integrally formed with or integrally attached to the main body through one or more link portions arranged between the retention element and the main body, and each of the one or more link portions extends along a part of the retention element in a circumferential direction of the retention element; wherein the retention element is integrally formed with or integrally attached to the main body through a single link portion, the retention element has a single cut-out portion extending from the apical end of the retention element to the coronal end of the retention element, and the link portion is arranged opposite to the cut-out portion in a radial direction of the retention element or adjacent to the cut-out portion in a circumferential direction of the retention element.

15. The dental fitting according to claim 12, wherein the retention element is integrally formed with or integrally attached to the main body through a single link portion, and the link is arranged opposite to the at least one projection of the attachment portion in a radial direction of the retention element.

16. The dental fitting according to claim 12, wherein the retention element is integrally formed with or integrally attached to the main body through at least two link portions, and the at least two link portions are arranged opposite to each other in a radial direction of the retention element.

17. The dental fitting according to claim 1, wherein the attachment portion comprises two or more projections, each extending in one or more directions substantially perpendicular to the direction from the attachment portion towards the coronal end of the main body.

18. The dental fitting according to claim 1, wherein the dental fitting further comprises a through hole extending through the dental fitting in the direction from a coronal end of the dental fitting to an apical end of the dental fitting.

19. The dental fitting according to claim 1, wherein the dental fitting has a marking, and/or the dental fitting further comprises an indication and/or tracking device.

20. The dental fitting according to claim 1, wherein the retention element is made of a metal, a polymer or a composite material.

21. A dental assembly comprising the dental fitting according to claim 1 and a dental component.

22. A method of attaching the dental fitting according to claim 1 to a dental component.
